(19) United States
(12) Patent Application Publication
(10) Pub. No.: US 2017/0273464 A1
(43) Pub. Date: Sep. 28, 2017

(54) BUOYANT RIGID SUNBATH AND METHOD FOR MAKING THE SAME

(71) Applicant: AV COMPOSITES, Saint Rémy de Provence (FR)

(72) Inventor: Vincent APRIN, Saint Rémy de Provence (FR)

(73) Assignee: AV COMPOSITES, Saint Rémy de Provence (FR)

(21) Appl. No.: 15/173,975

(22) Filed: Jun. 6, 2016

(30) Foreign Application Priority Data
Mar. 24, 2016 (FR) 16/70128

(51) Int. Cl. A47C 15/00; A47C 5/00; A47C 1/14

(52) U.S. Cl. CPC A47C 15/006; A47C 1/146; A47C 5/00; B29C 51/14

(57) ABSTRACT

Buoyant rigid sunbath comprising at least one hull shaped so as to allow the lying position of at least one person so as it includes a core consisting of closed and hydrophobic cells able to ensure the buoyancy of the sunbath with the person lying thereon and sandwiched between two watertight rigid facings each constituting a hull, the assembly forming a panel shaped as desired.

The invention concerns a buoyant rigid sunbath, or beach deck chair or lounge chair, which may be used not only on a terrace, on a beach but also in a swimming pool or in the sea or in any other place having a body of water.

The sunbaths or beach deck chairs are generally constituted either of a rigid structure or of a flexible structure while adopting several techniques to ensure the lying position of persons and, as appropriate, the buoyancy of the assembly.

A first technique for making a sunbath is to use a metal, plastic or wood mechanical structure, allowing to support a person and also providing an orientation, an angle at the head or the legs in order to improve the comfort of the person, but without being able to ensure the buoyancy.

It is known from WO 2011/082465 A1 that some beach deck chairs comprise an adjustable backrest constituted of parts allowing different settings of the backrest for better comfort of the user.

It is also known from WO 2015/071825 A1 and EP 1 243 204 A1 that some sunbaths comprise a structure to hold the person's body with a system adapted for its head but also providing an ultraviolet protection.

It is also known from FR 2 867 366 that some sunbath lounge chairs comprise a foldable structure with interchangeable wire.

It is also known from WO 2006/138523 A2 that some sunbaths comprise a mechanical structure allowing to have an orientation to both ends of the sunbath so that the person is always well exposed to sunlight.

It is known from FR 2 625 084 and FR 1 112 933 and FR 1 145 947 that some sunbaths comprise a mechanical structure including different mechanical mounting systems (pipes, shafts, pivots, . . . ) for the fastening of the wheels, removable arms, feet, and allowing to have a lying position of the person on this sunbath.

Other techniques allow not only the lying or semi-lying position of at least one person but also ensuring the buoyancy of the assembly, thus a second technique consists in using floats with a structure ensuring mobility. It is thus known from FR 1 467 280 that some sunbaths comprise a platform with floats having a pedal and propeller or wheel system and also a rudder (this product being commonly called a <<pedalo>>).

This second technique used as a float for example an expanded polystyrene foam block. Indeed, it is known from FR 1 522 616 that some sunbaths comprise a rectangular float made of light material such as expanded polystyrene which may integrate an ice box or storage having a pedal system.

A third technique consists in putting air or any other deformable flexible material (foam spheres) in a plastic flexible envelope, in a predefined shape and after air inflation and entrapment, the desired shape is obtained, these products are often called air mattresses or American mattresses.

Finally, a fourth technique consists in having air in a rigid and hollow structure, whose inner air volume constitutes a buoyancy reserve able to support the weight of the structure with a person lying thereon, and having a particular shape which suits the ergonomics and the comfort of the person, often made of plastic or of uniform colored resin. It is thus known, such as the products shown in the catalog <<Piscinéo>>, available on the website www.piscineo.com, managed by Wisenet company (located at the Chapelle Saint Luc—10600 FRANCE) specialized in the sale of swimming pools and accessories for individuals, that some sunbaths are constituted of resin-made hollow rigid hulls and having an ergonomic corrugated shape.

For the first technique and these related different types of structures, for the constitution of a sunbath, the mechanical strength is given by a metal, plastic or wood structure which allows having a rigid structure allowing the holding and the comfort, sometimes using a foam mattress for the person: although very practical, this sunbath technique does not allow its buoyancy and therefore cannot be used in a swimming pool, the sea, a water area.

For the second technique, for the constitution of a sunbath, some floats of different constitutions are used allowing to ensure a lying position and sometimes also its motorization are used. The significant drawback of this technique is its size by its large floats, its transportability and this technique does not allow a simple, vertical storage.

For the third technique, for the constitution of a sunbath, there is the air mattresses which are essentially used only in water and not on a terrace and the significant drawback is their durability because micro leaks often appear very quickly and no longer allow the buoyancy of these air mattresses, also not to mention the risk of being quickly gone with the wind, even low, due to the important lightness of these mattresses and their wind resistance.

For the fourth technique, for the constitution of a sunbath, there are used plastic hollow structures (often made by rotational molding), such as the products shown on the website <<www.piscineo.com>>, and which form a watertight completely closed hull with a parting line but like any hollow structure during use, micro-cracks appear resulting in a filling of the hollow structure, when laid on water, and which then no longer ensures the buoyancy and finally leaks.

The present invention aims to remedy these drawbacks by allowing not only to have a sunbath allowing a use on a terrace, a beach, on the water but also to have a stackable system with a small size and mostly guaranteeing a perfect buoyancy with no risk of having a sunbath which leaks because of micro-cracks and/or a loss of the system watertightness,

This invention allows obtaining a sunbath:
with a very ergonomic lying position,
which is buoyant (or floating) on all types of water (swimming pool, sea, lake, . . . ) but also usable on a terrace, the beach, . . . ,
providing safety as to the risks not only of buoyancy loss but also of being very quickly gone with the wind,
a geometry allowing a stacking on several tens of parts in a small size,
a lying position for one or two person(s) on the same sunbath,
a customization of the sunbath with photos of company logos (hotels, private beaches, trademark, . . . ).

To this end, the buoyant and rigid sunbath according to the invention, comprises at least one hull shaped so as to allow the lying position of at least one person, includes a core constituted of closed and hydrophobic cells able to ensure the buoyancy of the sunbath with the person lying thereon and sandwiched between two watertight rigid facings, each constituting a hull, the assembly forming a panel shaped as desired.

The object of the present invention is also achieved by a method for manufacturing or making a buoyant rigid sunbath comprising at least one hull shaped so as to allow the lying position of at least one person and such as:
a panel integrating in its inner portion a core composed of closed and hydrophobic cells able to ensure the buoyancy of the sunbath with the person lying thereon, is constituted and
this core is sandwiched between two watertight rigid facings shaped as desired, and able to ensure the mechanical strength of the sunbath by the created sandwich, each of these facings thus forming a hull.

Thus the sunbath according to the invention consists of a sandwich panel, comprising the outer/upper rigid facing (that is to say the facing accommodating the person lying thereon) and the inner/lower rigid facing (that is to say the facing opposite to the preceding one and which bears on the ground) made of screen-printable material (which may be screen-printed) or printable in plastic, metal material, which are composite and of a foam core comprising closed cells in order to ensure the buoyancy of the sunbath and to avoid any risk of submersion, although this core is not covered with a watertight envelope in, particular on its section which may not be covered with a protection edge between the two facings which sandwich it, these ones may also not be watertight but in ail cases they are mechanically linked to the inner core.

With this arrangement, under the action of a mechanical loading, when a person settles on the sunbath or during stacks of the different sunbaths, it is required to obtain a certain rigidity of the panel. This rigidity is determined by the thickness and the nature of the outer facing linked to its Young's modulus consisting of a homogeneous product such as metal (aluminum, . . . ) or of plastic (PVC, ABS, polycarbonate. ABS/ASA, ABS/PMMA, ASA, PP, etc.), or even with a fiber-based reinforcement (matt glass, rowing or fabric glass, or any other reinforcing fiber material) and of an organic matrix (polyester resin, epoxy, . . . ) in order to protect, transmit stresses to these reinforcements.

This outer facing is symmetrical between its upper and lower portion, and sandwiches the core which is involved not only in the rigidity of the sandwich panel but ensures its buoyancy,

The balance and the rigidity of the panel, of the sandwich structure (moment of inertia) will be determined according to the Young's modulus of the used materials, their densities and their thicknesses.

The innovative nature of this system is that the watertightness and mechanical functions of the sunbath are separated by.
outer facings able to ensure the mechanical strength of the sunbath by the created sandwich, each of these facings thus forming a hull, and also to ensure aesthetics, its decoration, a perfect surface condition giving a very pleasant nature to the touch, its facings sandwiching a core.
the inner core which, by its foam structure with closed and hydrophobic cells allows ensuring the perfect buoyancy of the sunbath with the person lying thereon and sandwiched between two watertight rigid facings, each constituting a hull, the assembly forming a panel shaped as desired. Micro-cracks of the facings will not result in a buoyancy loss of the sunbath.

Another innovative nature of this system is that the buoyant rigid sunbath comprises at least one hull shaped so as, to allow the lying position of at least one person and shaped by thermoforming, of the facings consisting at least of an organic material and which also ensure the protection, vis-à-vis the environment wear (UV, water, handling, . . . ), of the hydrophobic and closed-cells core, such as a rigid foam.

It is possible to use different manufacturing methods of this sunbath in sandwich panel such as the technology of bonding between the facings and the inner core such as polyurethane adhesives, epoxy, acrylics, cyanoacrylates, neoprene, hot melt, etc. but also other technologies of mechanical or chemical type assemblies. The chemical assembly technology provides a wide range of methods such as the foam injection, of the polyurethane type or other organic or inorganic materials, injected between the facings.

In one embodiment of the invention, the facings will be constituted of a metallic or organic material in the form of a sheet or plate which matches the shape of the sunbath or even by using a facing which has been formed in the shape of the sunbath by different systems such as the thermoforming, the vacuum molding, the spraying, . . . or any other technique allowing to give the shape of the sunbath to the facing through a mould. These facings will have a certain thickness in order to provide the desired rigidity to the sunbath These facings also allow ensuring a protection of the core against external agents such as the sun (UV), the water, the handling.

Advantageously, the outer facings may be constituted of a metallic or organic, plastic homogeneous product (PVC, ABS, polycarbonate, ABS/ASA, ABS/PMMA, ASA. PP, etc.), or even composite product with a fiber-based reinforcement (mat glass, rowing) and of an organic matrix (epoxy resin, polyester resin . . . ).

In one embodiment of the invention, the core layer may be obtained by a preform in the shape of the sunbath before the bonding of the outer facings, this preform may be obtained by cutting a block by thermal (hot wire cutting) or mechanical methods (abrasive wire cutting, numerical control cutting, machining robot), but this core layer may be also obtained by another method by injecting a product into a mould in the shape of the core or even by injecting this core between the facings and will match the shape of the outer facing during the expansion of the foam in order to allow a complete filling of the cavities of the panel. In the case of the injection, the injected product also participates in the bonding of the different constituent materials such as the composite rigid outer facing showing the geometric shapes arid the central core.

Advantageously, the material of the inner core is selected from the following closed-cells hydrophobic materials: polystyrene organic foam, or polyvinyl chloride, or polyurethane, or polyethylene terephthalate, or even polyethylene, . . . or any syntactic foam or even any organic or mineral foam with a thickness ranging from 30 to 100 mm and a density ranging from 10 to 300 kg/m³, having closed cells in order to allow its buoyancy. It allows, by its closed cells, to eliminate the need for rims or watertight edges.

The panel consisting in the closed-cells core and the facings, has preferably the shape of at least a sine wave, obtained during the constitution of the sandwich and adapted to the lying position of at least one person: this sine shape of the sunbath may be obtained by thermoforming, injection or mechanical cutting (abrasive wire cutting, numerical control cutting, machining robot), or by thermal cutting (hot wire).

In one embodiment of the invention, the side of the sunbath, corresponding to the section of the core between the rim of the two facings which sandwich it, may be covered and obtained directly by one or both facing(s) integrating a rounded peripheral shape in order to have a perfect aesthetics or constituted of a plastic insert on the periphery and constituting an edge bonded on the section of the core in order to provide also an aesthetics on the periphery of the sunbath but also to ensure the protection of these sides from shocks and bad weather.

The invention will be better understood using the description given with reference to the appended schematic drawings showing, by way of examples, several embodiments of the panel according to the invention.

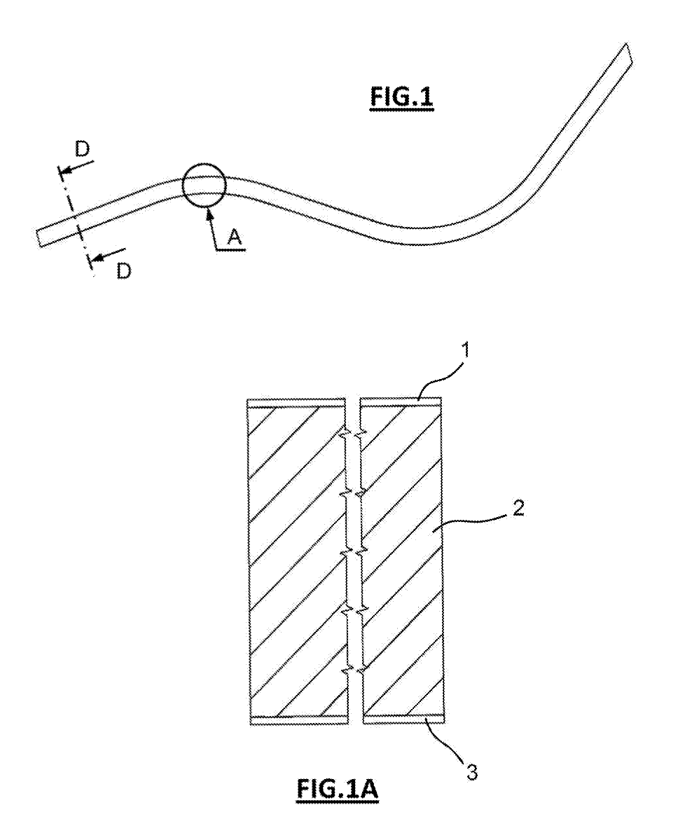

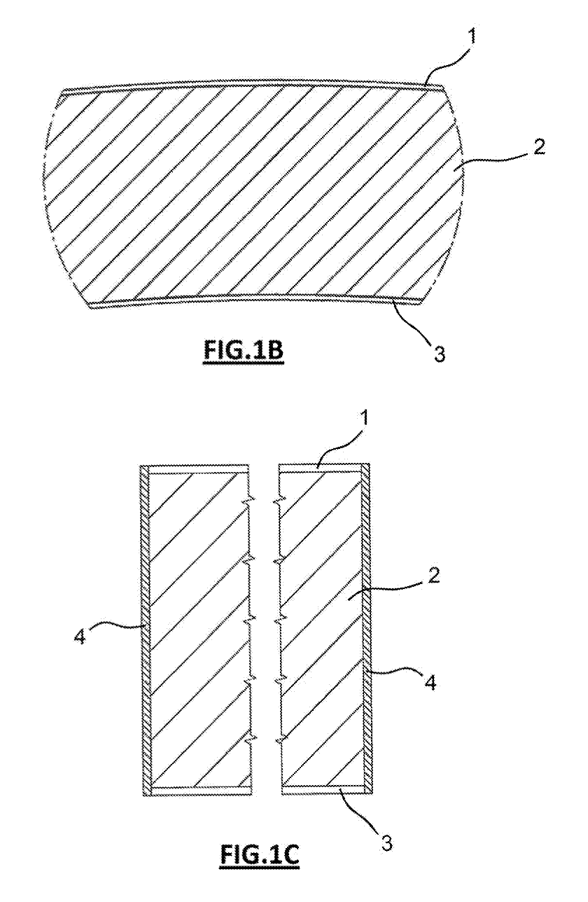

FIG. 1 is a side view of an embodiment of a sunbath according to the invention,

FIG. 1A is a partial cross-sectional view along DD of the sunbath in FIG. 1 without its peripheral edge,

FIG. 1B is a partial side view of the detail A of the sunbath of FIG. 1 without its peripheral edge,

FIG. 1C is a partial cross-sectional view along DD of the sunbath of FIG. 1 with its peripheral edge,

FIG. 1D is a partial side view of the detail A of the sunnbath of FIG. 1 with its peripheral edge,

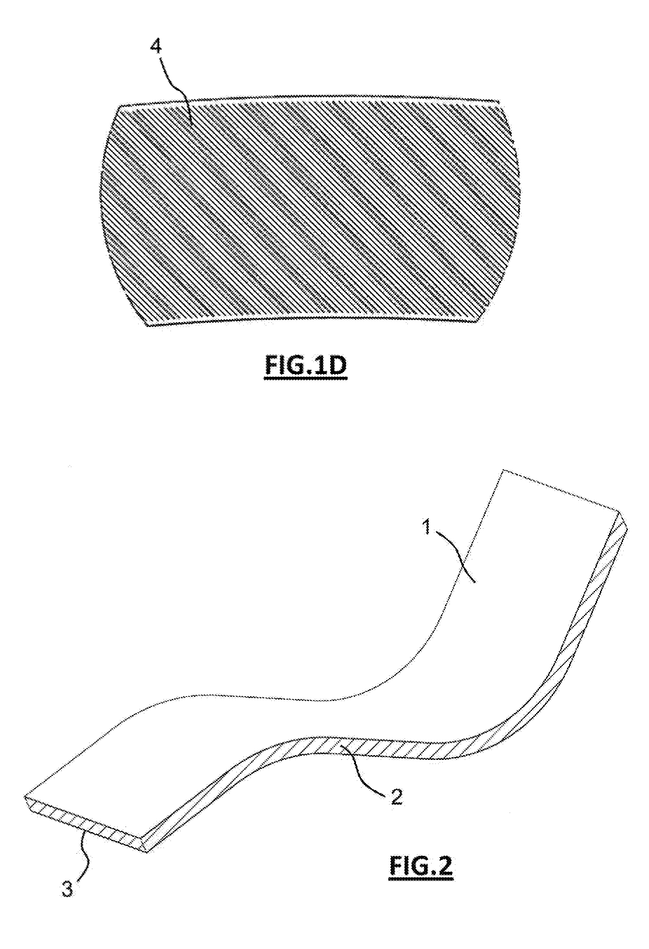

FIG. 2 is a side elevation view of a sunbath with outer facings presenting each the shape of a sheet, or a plate or a skin, obtained by shaping technologies integrating peripheral rounded forms.

In the embodiment shown in FIG. 2, the sunbath is composed of a core 2, disposed between two rigid facings, namely an outer facing 1, or called higher facing, having the aspect, the shape and the color of the sunbath or even may accommodate a pattern or photo and another facing called lower stiffening facing 3. In FIGS. 1A and 1B, the sunbath shows no edge 4 on its periphery but shows directly the section of the core 2.

In another embodiment shown in FIGS. 1C and 1D, the sunbath is still composed of a core 2, disposed between two rigid facings 1 and 3 but integrating an edge 4. This edge 4 may be inserted or integrated with the facings 1 or 3 in order to create a closed double-hull shape and completely enclosing the core 2.

The lower facing 3, which may be qualified as stiffening facing, is separated from the outer/upper rigid facing 1 by the core 2 made in a closed-cells hydrophobic material in order to ensure the buoyancy. This lower stiffening facing 3 may have a flat surface in order to ensure the perfect bath stability of the sunbath during its use.

By way of example, a sandwich panel intended for king a sunbath of FIG. 2, consists of the following elements:
the outer facings 1 and 3 formed of a sheet or plate which will match the shape of the sunbath or even by using a facing which has been formed in the shape of the sunbath by different systems such as the thermoforming, the vacuum molding, the spraying, . . . integrating or not the edge 4 or any other technique allowing to provide the shape of the sunbath. These facings 1 and 3 may be constituted of a homogeneous product of thickness ranging from 1 to 10 mm, such as a metallic or plastic (PVC, ABS, polycarbonate, ABS/ASA, ABS/PMMA, ASA, PP, etc.) product, or even a composite product consisting of fiber-based reinforcement (matt glass, rowing or any other organic material) and of an organic matrix such as a resin (epoxy, polyurethane, . . . ). These facings 1 and 3 will also allow guaranteeing the strength over time and more particularly UV. At least, the upper facing 1 may accommodate or comprise on its face oriented outwardly either a color or a decoration by printing technologies, inkjet, laser or even obtained by sublimation, transfer, by setting up a decoration film or any other decorative technology,

the central core 2 constituted of closed-cells hydrophobic material in order to provide the buoyancy, having a density comprised between 10 and 300 kg/m³, of a thickness ranging from 30 to 100 mm and which may be constituted of polystyrene foam, polyurethane foam, polyvinyl chloride foam, polyethylene foam or any other organic or mineral cores having hydrophobic and, dosed cells in order to allow its buoyancy.

the edge 4 in the version during use of sheets or plates for the facings 1 and 3 which may consist of organic material, bonded on the section of the core 2 and linking the rims of the two facings 1, 3 over the entire periphery of the sunbath, it allows hiding said section of the core 2 on the sides of the sunbath, protecting the foam of this core 2 from the UV and from any other external attacks such as mechanical attacks during its handling.

Of course, the different layers of the panel are, in a known manner, linked to each other by an adhesive layer whose nature is adapted for products which must be assembled, except the case of the injection between the rigid outer facings representative of the shapes of the sunbath.

1. A method for making a buoyant rigid sunbath comprising at least one hull shaped so as to allow the lying position of at least one person, comprising:
constituting a panel integrating in its inner portion a core consisting of closed and hydrophobic cells able to ensure the buoyancy of the buoyant rigid sunbath with the person lying thereon, and
said core is sandwiched between at least two watertight rigid facings having the desired shape, and able to ensure the mechanical strength of the sunbath by the created sandwich, each of these facings thus forming a hull.

2. The method according to claim 1, wherein the facings, consisting of organic materials and which also ensure the protection of the foam core regarding the environment (UV, water, handling, . . . ), are shaped by thermoforing.

3. A buoyant rigid sunbath comprising at least one hull shaped so as to allow the lying position of at least one person, and including an inner core consisting of hydrophobic closed cells able to ensure the buoyancy of the buoyant rigid sunbath with the person lying thereon and sandwiched between two watertight rigid facings each constituting a hull, the assembly forming a panel shaped as desired.

4. The buoyant rigid sunbath according to claim wherein the two facings are mechanically linked to the inner core and are able to transmit the forces and to provide the rigidity to the buoyant rigid sunbath.

5. The buoyant rigid sunbath according to claim 3, wherein the panel, consisting of the closed-cells of the inner core and of the facings, has at least the shape of a sine wave, obtained during the constitution of the sandwich and adapted to the lying position of at least one person.

6. The buoyant rigid sunbath according to claim 3, wherein at least an upper facing comprises on its face oriented outwardly at least either a color or a decoration.

7. The buoyant rigid sunbath according to claim 3, wherein the closed-cells of the inner core is a hydrophobic foam of a thickness ranging from 30 to 100 mm and of a density ranging from 10 to 300 kg/m³.

8. The buoyant rigid sunbath according to claim 3, wherein the facings are each of a thickness ranging from 1 to 10 mm and consisting at least of an organic material.

9. The buoyant rigid sunbath according to claim 8, wherein the facings are made of composite material consisting of fiber-based reinforcements and of an organic matrix.

10. The buoyant rigid sunbath according to claim 3, wherein a facing, called lower facing as opposite to a facing intended to support a person and called upper facing, comprises at least one flat surface.

11. The buoyant rigid sunbath according to claim 3, wherein the facings consist in sheets or plates, and an edge constituted of organic material is bonded to the section of the inner core and links the rims of the two facings on the entire periphery of the sunbath.
